(19) United States
(12) Patent Application Publication
(10) Pub. No.: US 2024/0146485 A1
(43) Pub. Date: May 2, 2024

(54) CONFIGURATION AND TRANSMISSION OF CHANNEL STATE INFORMATION REFERENCE SIGNAL

(71) Applicant: NOKIA TECHNOLOGIES OY, Espoo (FI)

(72) Inventors: Ahmad AWADA, Munich (DE); Panagiotis SPAPIS, Munich (DE); Umur KARABULUT, Munich (DE); Sanjay GOYAL, Denville, NJ (US); Timo KOSKELA, Oulu (FI); Keeth Saliya JAYASINGHE LADDU, Espoo (FI)

(21) Appl. No.: 17/979,533

(22) Filed: Nov. 2, 2022

(51) Int. Cl. H04L 5/00; H04W 36/00

(52) U.S. Cl. CPC H04L 5/0057; H04W 36/0058

(57) ABSTRACT

Systems, methods, apparatuses, and computer program products for configuration and transmission of a channel state information reference signal (CSI-RS). A method may include forwarding, to a network element, synchronization signal block measurements of a target cell along with synchronization signal block indices. The method may also include requesting the network element to provide a channel state information reference signal configuration for a channel state information reference signal index whose source reference signal corresponds to at least one of the synchronization signal block indices. The method may further include receiving the channel state information reference signal configuration from the network element. In addition, the method may include transmitting the channel state information reference signal configuration to a user equipment. Further, the method may include receiving a measurement report on the channel state information reference signal index according to the channel state information reference signal configuration.

### FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to apparatuses, systems, and/or methods for configuration and transmission of a channel state information reference signal (CSI-RS).

### BACKGROUND

Examples of mobile or wireless telecommunication systems may include the Universal Mobile Telecommunications System (UMTS) Terrestrial Radio Access Network (UTRAN), LTE Evolved UTRAN (E-UTRAN), LTE-Advanced (LTE-A), MulteFire, LTE-A Pro, and/or fifth generation (5G) radio access technology or NR access technology. 5G wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the IoT.

### SUMMARY

Some example embodiments may be directed to a method. The method may include forwarding, to a network element, synchronization signal block measurements of a target cell along with synchronization signal block indices. The method may also include requesting the network element to provide a channel state information reference signal configuration for a channel state information reference signal index whose source reference signal corresponds to at least one of the synchronization signal block indices. The method may further include receiving the channel state information reference signal configuration from the network element. In addition, the method may include transmitting the channel state information reference signal configuration to a user equipment. Further, the method may include receiving a measurement report on the channel state information reference signal index according to the channel state information reference signal configuration.

Other example embodiments may be directed to an apparatus. The apparatus may include at least one processor and at least one memory including computer program code. The at least one memory and computer program code may also be configured to, with the at least one processor, cause the apparatus at least to forward, to a network element, synchronization signal block measurements of a target cell along with synchronization signal block indices. The apparatus may also be caused to request the network element to provide a channel state information reference signal configuration for a channel state information reference signal index whose source reference signal corresponds to at least one of the synchronization signal block indices. The apparatus may further be caused to receive the channel state information reference signal configuration from the network element. In addition, the apparatus may be caused to transmit the channel state information reference signal configuration to a user equipment. Further, the apparatus may be caused to receive a measurement report on the channel state information reference signal index according to the channel state information reference signal configuration.

Other example embodiments may be directed to an apparatus. The apparatus may include means for forwarding, to a network element, synchronization signal block measurements of a target cell along with synchronization signal block indices. The apparatus may also include means for requesting the network element to provide a channel state information reference signal configuration for a channel state information reference signal index whose source reference signal corresponds to at least one of the synchronization signal block indices. The apparatus may further include means for receiving the channel state information reference signal configuration from the network element. In addition, the apparatus may include means for transmitting the channel state information reference signal configuration to a user equipment. Further, the apparatus may include means for receiving a measurement report on the channel state information reference signal index according to the channel state information reference signal configuration.

In accordance with other example embodiments, a non-transitory computer readable medium may be encoded with instructions that may, when executed in hardware, perform a method. The method may include forwarding, to a network element, synchronization signal block measurements of a target cell along with synchronization signal block indices. The method may also include requesting the network element to provide a channel state information reference signal configuration for a channel state information reference signal index whose source reference signal corresponds to at least one of the synchronization signal block indices. The method may further include receiving the channel state information reference signal configuration from the network element. In addition, the method may include transmitting the channel state information reference signal configuration to a user equipment. Further, the method may include receiving a measurement report on the channel state information reference signal index according to the channel state information reference signal configuration.

Other example embodiments may be directed to a computer program product that performs a method. The method may include forwarding, to a network element, synchronization signal block measurements of a target cell along with synchronization signal block indices. The method may also include requesting the network element to provide a channel state information reference signal configuration for a channel state information reference signal index whose source reference signal corresponds to at least one of the synchronization signal block indices. The method may further include receiving the channel state information reference signal configuration from the network element. In addition, the method may include transmitting the channel state information reference signal configuration to a user equipment. Further, the method may include receiving a measurement report on the channel state information reference signal index according to the channel state information reference signal configuration.

Other example embodiments may be directed to an apparatus that may include circuitry configured to forward, to a network element, synchronization signal block measurements of a target cell along with synchronization signal block indices. The apparatus may also include circuitry configured to request the network element to provide a channel state information reference signal configuration for a channel state information reference signal index whose source reference signal corresponds to at least one of the synchronization signal block indices. The apparatus may further include circuitry configured to receive the channel state information reference signal configuration from the network element. In addition, the apparatus may include circuitry configured to transmit the channel state information reference signal configuration to a user equipment. Further, the apparatus may include circuitry configured to receive a measurement report on the channel state information reference signal index according to the channel state information reference signal configuration.

Certain example embodiments may be directed to a method. The method may include configuring a user equipment with a list of channel state information reference signal indices for a target cell. The method may also include receiving a measurement report of a subset of the channel state information reference signal indices in the list. According to certain example embodiments, the report may be received based on an activation command from the apparatus, or based on satisfaction of a condition for the user equipment.

Other example embodiments may be directed to an apparatus. The apparatus may include at least one processor and at least one memory including computer program code. The at least one memory and computer program code may be configured to, with the at least one processor, cause the apparatus at least to configure a user equipment with a list of channel state information reference signal indices for a target cell. The apparatus may also be caused to receive a measurement report of a subset of the channel state information reference signal indices in the list. According to certain example embodiments, the report may be received based on an activation command from the apparatus, or based on satisfaction of a condition for the user equipment.

Other example embodiments may be directed to an apparatus. The apparatus may include means for configuring a user equipment with a list of channel state information reference signal indices for a target cell. The apparatus may also include means for receiving a measurement report of a subset of the channel state information reference signal indices in the list. According to certain example embodiments, the report may be received based on an activation command from the apparatus, or based on satisfaction of a condition for the user equipment.

In accordance with other example embodiments, a non-transitory computer readable medium may be encoded with instructions that may, when executed in hardware, perform a method. The method may include configuring a user equipment with a list of channel state information reference signal indices for a target cell. The method may also include receiving a measurement report of a subset of the channel state information reference signal indices in the list. According to certain example embodiments, the report may be received based on an activation command from the apparatus, or based on satisfaction of a condition for the user equipment.

Other example embodiments may be directed to a computer program product that performs a method. The method may include configuring a user equipment with a list of channel state information reference signal indices for a target cell. The method may also include receiving a measurement report of a subset of the channel state information reference signal indices in the list. According to certain example embodiments, the report may be received based on an activation command from the apparatus, or based on satisfaction of a condition for the user equipment.

Other example embodiments may be directed to an apparatus that may include circuitry configured to configure a user equipment with a list of channel state information reference signal indices for a target cell. The apparatus may also include circuitry configured to receive a measurement report of a subset of the channel state information reference signal indices in the list. According to certain example embodiments, the report may be received based on an activation command from the apparatus, or based on satisfaction of a condition for the user equipment.

Certain example embodiments may be directed to a method. The method may include receiving, from a network element, a configuration comprising a list of channel state information reference signal indices for a target cell. The method may also include performing channel state information reference signal measurements for a subset of channel state information reference signal indices in the list of channel state information reference signal indices. The method may further include reporting the channel state information reference signal measurements for the subset of channel state information reference signal indices to the network element. According to certain example embodiments, the performance and report of the channel state information reference signal measurements may be initiated based on reception of an activation command from the network element, or based on satisfaction of a condition.

Other example embodiments may be directed to an apparatus. The apparatus may include at least one processor and at least one memory including computer program code. The at least one memory and computer program code may be configured to, with the at least one processor, cause the apparatus at least to receive, from a network element, a configuration comprising a list of channel state information reference signal indices for a target cell. The apparatus may also be caused to perform channel state information reference signal measurements for a subset of channel state information reference signal indices in the list of channel state information reference signal indices. The apparatus may further be caused to report the channel state information reference signal measurements for the subset of channel state information reference signal indices to the network element. According to certain example embodiments, the performance and report of the channel state information reference signal measurements may be initiated based on reception of an activation command from the network element, or based on satisfaction of a condition.

Other example embodiments may be directed to an apparatus. The apparatus may include means for receiving, from a network element, a configuration comprising a list of channel state information reference signal indices for a target cell. The apparatus may also include means for performing channel state information reference signal measurements for a subset of channel state information reference signal indices in the list of channel state information reference signal indices. The apparatus may further include means for reporting the channel state information reference signal measurements for the subset of channel state information reference signal indices to the network element. According to certain example embodiments, the performance and report of the channel state information reference signal measurements may be initiated based on reception of an activation command from the network element, or based on satisfaction of a condition.

In accordance with other example embodiments, a non-transitory computer readable medium may be encoded with instructions that may, when executed in hardware, perform a method. The method may include receiving, from a network element, a configuration comprising a list of channel state information reference signal indices for a target cell. The method may also include performing channel state information reference signal measurements for a subset of channel state information reference signal indices in the list of channel state information reference signal indices. The method may further include reporting the channel state information reference signal measurements for the subset of channel state information reference signal indices to the network element. According to certain example embodiments, the performance and report of the channel state information reference signal measurements may be initiated based on reception of an activation command from the network element, or based on satisfaction of a condition.

Other example embodiments may be directed to a computer program product that performs a method. The method may include receiving, from a network element, a configuration comprising a list of channel state information reference signal indices for a target cell. The method may also include performing channel state information reference signal measurements for a subset of channel state information reference signal indices in the list of channel state information reference signal indices. The method may further include reporting the channel state information reference signal measurements for the subset of channel state information reference signal indices to the network element. According to certain example embodiments, the performance and report of the channel state information reference signal measurements may be initiated based on reception of an activation command from the network element, or based on satisfaction of a condition.

Other example embodiments may be directed to an apparatus that may include circuitry configured to receive, from a network element, a configuration comprising a list of channel state information reference signal indices for a target cell. The apparatus may also include circuitry configured to perform channel state information reference signal measurements for a subset of channel state information reference signal indices in the list of channel state information reference signal indices. The apparatus may further include circuitry configured to report the channel state information reference signal measurements for the subset of channel state information reference signal indices to the network element. According to certain example embodiments, the performance and report of the channel state information reference signal measurements may be initiated based on reception of an activation command from the network element, or based on satisfaction of a condition.

### BRIEF DESCRIPTION OF THE DRAWINGS

For proper understanding of example embodiments, reference should be made to the accompanying drawings, wherein:

FIG. 1 illustrates an example signal flow diagram for Layer 1/Layer 2 (L1/L2) inter-cell mobility.

FIG. 2 illustrates an example synchronization signal block (SSB) and channel state information reference signal (CSI-RS) indices in a cell.

FIG. 3 illustrates an example signal flow diagram, according to certain example embodiments.

FIG. 4 illustrates an example of another signal flow diagram, according to certain example embodiments.

FIG. 5 illustrates an example of a further signal flow diagram, according to certain example embodiments.

FIG. 6 illustrates an example flow diagram of a method, according to certain example embodiments.

FIG. 7 illustrates an example flow diagram of another method, according to certain example embodiments.

FIG. 8 illustrates an example flow diagram of a further method, according to certain example embodiments.

FIG. 9 illustrates a set of apparatuses, according to certain example embodiments.

### DETAILED DESCRIPTION

It will be readily understood that the components of certain example embodiments, as generally described and illustrated in the figures herein, may be arranged and designed in a wide variety of different configurations. The following is a detailed description of some example embodiments of systems, methods, apparatuses, and computer program products for configuration and transmission of a CSI-RS. For instance, certain example embodiments may be directed to the configuration and transmission of CSI-RS in Layer 1 (L1) or Layer 2 (L2) inter-cell mobility.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, “network” or other similar language throughout this specification may be used interchangeably. Additionally, “prepared target cell”, “prepared candidate target cell”, “prepared cell”, “candidate cell”, and “candidate target cell” may be used interchangeably herein. Further, “L1/2 inter-cell mobility”, “lower layer mobility”, and “L1/2 handover” may be used interchangeably herein. Further, as used herein, a serving distributed unit (DU) may control at least one cell, among which one cell may be a serving cell. Thus, in certain example embodiments described herein, when a serving DU sends or receives, the serving DU may send or receive data using a radio link of the serving cell. This same concept regarding the serving DU may also be applicable for a target cell/DU described herein.

As used herein, “at least one of the following: <a list of two or more elements>” and “at least one of <a list of two or more elements>” and similar wording, where the list of two or more elements are Joined by “and” or “or,” mean at least any one of the elements, or at least any two or more of the elements, or at least all the elements.

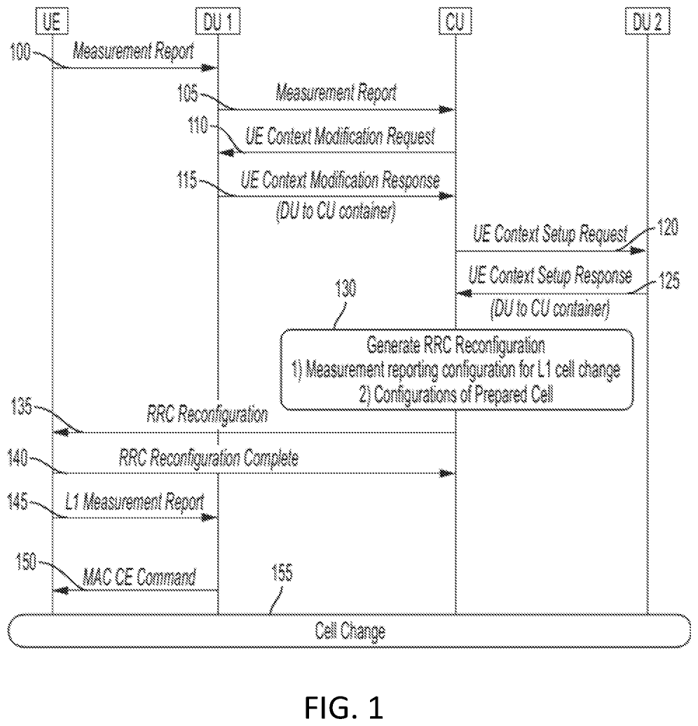

As described in the technical specifications of 3^{rd} Generation Partnership Project (3GPP), L1/2 inter-cell mobility may be performed by a medium access control (MAC) layer terminated in a distributed unit (DU). FIG. 1 illustrates an example signal flow diagram for L1/2 inter-cell mobility. In particular, FIG. 1 shows an exemplary implementation for the signaling diagram of L1/2 inter-cell mobility from a serving cell in DU1 to a target cell in DU2 (inter-DU intra-centralized unit (CU) scenario). The same diagram may be applicable in cases of intra-DU intra-CU cell change where DU1 may be the same as DU2.

As illustrated in FIG. 1, at 100, the UE may send a measurement report containing cell quality measurements of serving and neighboring cells to DU1. In this example, the UE may be configured by the serving cell to send the measurement report early when it still has a good connection to the serving cell. At 105, DU1 may send the measurement report to the CU, which can identify a potential set of candidate target cells to which the UE may be handed over. In this example, the CU may identify candidate target cells that are served by DU1 (controlling the serving DU/cell as well), and another DU2 that is controlled by the same CU.

At 110, the CU may request the preparation of a candidate target cell controlled by DU1 by sending a UE context modification request message to DU1. At 115, DU1 may transmit the configuration of the UE in a UE context modification response message that may include a container from DU to CU. According to certain example embodiments, the container from DU to CU may include a cell group configuration information element, which may be used to configure a cell group (can include only one cell) including one medium access control (MAC) entity, a set of logical channels with associated RLC entities and a primary cell (SpCell), and one or more secondary cells (SCells). In some example embodiments, the cell group configuration may be part of a lower layer mobility (LLM) configuration of the prepared target cell that is generated by the CU using some information from DU (e.g., cell group configuration). As illustrated in FIG. 1, operations 120 and 125 may be performed by DU2 to prepare target cell(s) that are controlled by DU2, and operations 120 and 125 may be similar to operations 110 and 115, respectively.

At 130, having received the UE configurations for the candidate target cell(s), the CU may generate a radio resource control (RRC) reconfiguration that may be transmitted to the UE at 135. Among other information, the RRC reconfiguration message may include measurement reporting configuration for L1/2 handover (i.e., configuration on how to report L1 beam measurements of serving and target cells at 145). The RRC reconfiguration message may also include configuration of the prepared candidate cell(s) that the UE needs to execute when it receives a MAC control element (MAC CE) command to change the serving cell (perform handover) as shown at 150. At 145, after confirming the RRC reconfiguration to the network at 140, the UE may periodically report the L1 beam measurement of serving and candidate target cells.

At 150, upon determining that there is a target candidate cell that has a better radio link/beam measurement than the serving cell (e.g., L1-reference signal received power (RSRP) of target beam measurement is greater than L1-RSRP of the serving beam measurement plus an offset for an amount of time (e.g., time-to-trigger (TTT)), the serving cell may send a MAC CE or a L1 message to trigger a cell change to the target candidate cell. At 155, the handover from the serving cell to the target cell may be executed by the UE.

To trigger the cell change at 150 of FIG. 1, the serving DU (e.g., DU1) may indicate a transmission configuration index (TCI) state which may include quasi co-location (QCL) information for receiving on physical downlink control channel/physical downlink shared channel (PDCCH/PDSCH) from the target cell (e.g., DL reception) and/or for transmitting on physical uplink control channel/physical uplink shared channel (PUCCH/PUSCH) (uplink (UL) transmission). In some cases, it may be possible for the UE to receive, after operation 150, a PDCCH from the target cell scheduling an UL grant to send (e.g., RRC reconfiguration complete message) to the target cell, or the UE may need to send the message directly on pre-allocated UL grant in case of random access channel (RACH)-less handover.

As noted above, the TCI state may include QCL information for receiving on PDCCH/PDSCH from the target cell and/or for transmitting on PUCCH/PUSCH. The QCL information may include RS, QCL typeA, typeB, typeC and typeD, and a bandwidth part (bwp) which the RS is located. QCL typeA may be defined to include a Doppler shift, Doppler spread, average delay, and delay spread. Additionally, QCL typeB may be defined to include Doppler shift and Doppler spread. Further, QCL typeC may be defined to include Doppler shift and average delay, and QCL typeD may be defined to include a spatial Rx parameter.

For switching a serving beam, one of the following options may be allowed for QCL information. For instance, in a first option, for QCL-type 1, the referenceSignal=tracking RS (TRS) index, where TRS is a special configuration of the CSI-RS index, and QCL-Type=A. Further, for QCL-Type2 (applicable in frequency range 2 (FR2)), referenceSignal=same TRS index and QCL-Type=D. In a second option, for QCL-Type1, referenceSignal=TRS index and QCL-Type=A. Further, for QCL-Type2 (applicable in FR2), referenceSignal=CSI-RS index with repetition and QCL-Type=D. In the first option for QCL information noted above and for FR1, the serving cell may indicate to the TRS index as the QCL source may be used by the UE to estimate the channel properties (e.g., Doppler shift, Doppler spread, average delay, and/or delay spread) for receiving PDCCH/PDSCH and/or transmitting PUCCH/PUSCH.

In 3GPP, the CSI-RS resource set information element (IE) may include at least one CSI-RS resource identified by an index/ID (non-zero power (NZP)-CSI-RS-ResourceID which is referred to in QCL-information as well), and indicates whether the transmission of the CSI-RS index is repeated by setting a repetition flag to on or off. A CSI-RS index may be referred to as TRS when trs-info is set to true. Additionally, for a TRS, repetition and measurement reporting may not be expected to be configured.

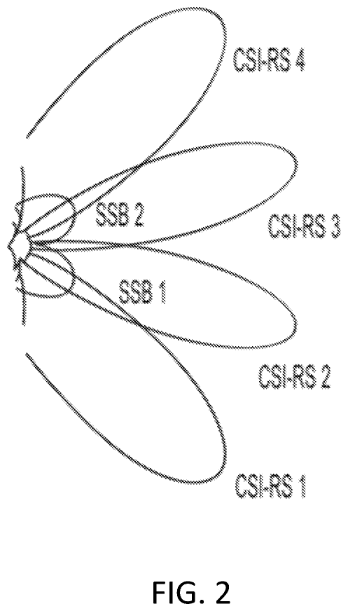

FIG. 2 illustrates example synchronization signal block (SSB) and CSI-RS indices in a cell. For each CSI-RS index (configured as TRS or non-TRS), there may be an SSB-index that serves as a source RS for QCL information. This may be done either via direct or indirect QCL chain reference. In particular, for direct QCL reference, a SSB may be configured as the QCL source of the CSI-RS. Further, for indirect QCL reference, a CSI-RS may have another CSI-RS as the QCL reference where reference CSI-RS has a SSB as its QCL reference. Given that SSB may typically be transmitted using a wider beam compared to a CSI-RS, multiple CSI-RS indices may be associated with the same source SSB-index. For instance, as illustrated in FIG. 2, SSB 1 may serve as the source RS for QCL information of CSI-RS 1 and CSI-RS 2, and SSB 2 for CSI-RS 3 and 4.

For inter-cell measurement purposes (e.g., for inter-cell beam management (ICBM)/LLM), a set of one or more SSBs may be associated with a physical cell ID (PCI). To associate a CSI-RS signal with a specific cell, the association may be performed in an indirect manner. If an SSB associated with a specific PCI is configured as a QCL source for a CSI-RS signal, the SSB may also associate the CSI-RS with the same PCI as the QCL source (SSB). The serving DU may also configure the UE to report SSB and CSI-RS measurements (i.e., the serving DU may provide the measurement configuration to the CU, which provides the configuration to the UE via RRC). Based on the received SSB measurements, the serving DU may decide to trigger LLM to SSB (e.g., one of target cells when, for example, the L1 SSB 1 measurement of a prepared target cell is better than that of a serving cell). Additionally, the serving DU may trigger a cell change by sending the TCI state indicating the CSI-RS index, which may be used for estimating channel properties for receiving PDCCH/PDSCH. The serving DU may also identify the proper CSI-RS index (CSI-RS 1 or 2 in the example above) from the CSI-RS measurements that are configured and reported by the UE. Further, when TRS is the QCL reference, SSB measurements may be used to identify and configure the appropriate TRS as the QCL reference in the TCI state.

In order for the serving DU to indicate the TCI state including the QCL information with CSI-RS index as the source RS, the target DU controlling the prepared target cells may provide a list of CSI-RS that may be measured by the UE. The serving DU may be aware of the configuration a well in order to select an appropriate TCI state of the target cell for the UE to be used upon cell switch. Since it may be challenging for the target DU to predict the direction the UE would be moving to, the target DU may configure all CSI-RSs for the UE. However, such configuration may result in certain drawbacks including, for example, the network having to transmit all CSI-RS indices even when they are not needed (for instance, when their source SSB-index is not detectable by the UE). Another drawback is that the UE would need to perform measurements on all configured CSI-RS indices of the prepared target cell, which may be a limiting factor given that multiple cells may be prepared in LLM. In view of the above, certain example embodiments described herein may resolve these drawbacks by being able to reduce the unnecessary CSI-RS configurations and transmissions performed by the prepared target cells, and to reduce the unnecessary CSI-RS measurements performed by the UE.

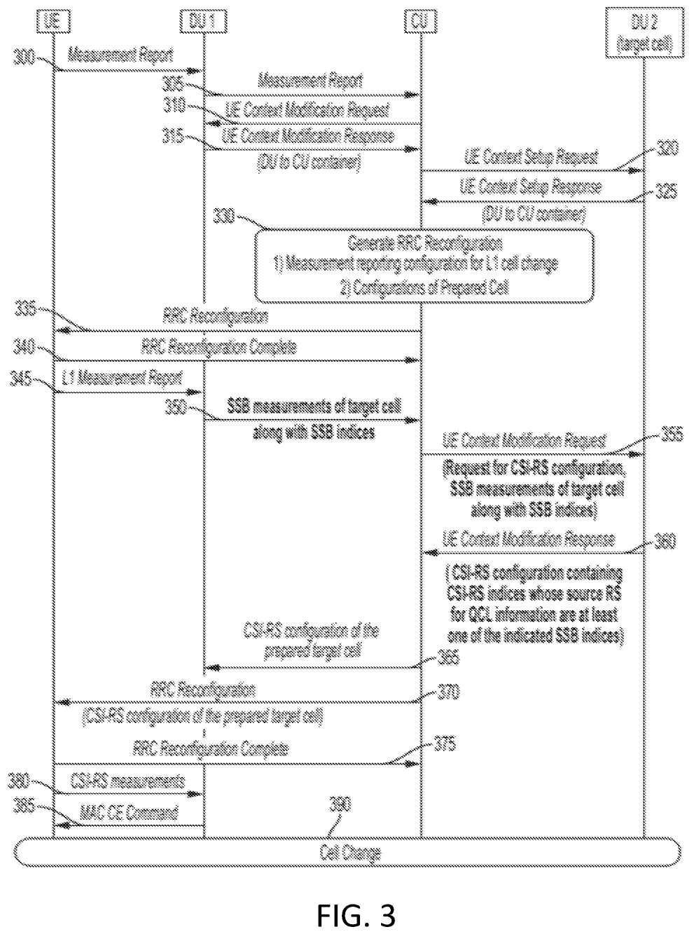

FIG. 3 illustrates an example signal flow diagram, according to certain example embodiments. In particular, FIG. 3 illustrates an example embodiment where the relevant CSI-RS indices are configured to the UE. As shown in FIG. 3, operations 300 to 345 are similar to operations 100 to 145 in FIG. 1. Thus, the description of operations 300 to 345 may be similar to the above description of operations 100 to 145.

At 350, DU1 may transmit SSB measurements of the target cell to the CU, and may also include with the transmission, an identification/list of SSB indices. For instance, in certain example embodiments, the serving cell may determine the SSBs with the strongest SSB measurements (up to N strongest SSB measurements, or N SSB measurements above a certain quality threshold; a SSB measurement may be L1-RSRP or L1-SINR), and request the target cell (e.g., DU2) to provide CSI-RS configuration (operation 355) only for the CSI-RS indices whose source RS QCL information correspond to at least one of the SSB indices that are indicated by the serving cell. According to certain example embodiments, the request from the serving cell may be performed directly or indirectly via the CU. As illustrated in the example of FIG. 3, the request from the serving cell to the target cell may be transmitted indirectly via the CU.

According to certain example embodiments, if the source DU (e.g., DU1) detects that the strongest SSB for a prepared target cell is SSB index 1 (see, for example, FIG. 2), the source DU may request the target DU (e.g., DU2) to provide the CSI-RS configuration containing the CSI-RS indices whose source RS is SSB1. As illustrated in FIG. 3, at 360, the target DU may provide the configuration for CSI-RS index 1 and 2, and activate the transmission of CSI-RS index 1 and 2 if not activated already. That is, the target DU may provide CSI-RS configuration containing CSI-RS indices whose source RS for QCL information are at least one of the indicated SSB indices.

As noted above, at 350, the serving cell may forward the SSB indices along with their corresponding measurements (e.g., L1-RSRP or L1-SINR). The measurement may be the latest measurement or average or weighted average over past measurements. Additionally, the SSB measurements (used to determine for which SSBs to request) may include the average quality value (e.g., RSRP) of N-latest measurements for a particular SSB index. In other example embodiments, the SSB measurement may be further configured by the CU so that the source DU may determine and send to the CU (for further forwarding to the target DU) average SSB measurement results in the last K-time periods (e.g., K may be multiples of reporting periods or K-Y milliseconds/slots/frames).

In certain example embodiments, an SSB for which the CSI-RS is requested, may be reported by the UE in at least N1/M1 time during a time period (e.g., M1 may be 5 reporting periods, and N1 may be 4 reporting periods resulting in N1/M1=4/5). As described above, in some example embodiments, at 360, DU2 may provide the requested CSI-RS configuration to the serving DU/CU, which may in turn, at 370, provide the requested CSI-RS configuration to the UE. At 375, the UE may confirm the RRC reconfiguration to the CU. As illustrated in FIG. 3, the UE may be configured with the relevant CSI-RS indices (see operation 370), and at 380, may perform measurements on this subset of CSI-RS indices. In addition, DU2 may activate the transmission of a subset of CSI-RS indices if they are not already active. In other example embodiments, DU1 may transmit an updated list of the strongest SSB indices and measurements to DU2, and DU2 may then modify the CSI-RS configuration that may be provided to the UE. Once the UE has performed the measurements on the subset of CSI-RS indices, at 385, DU1 may trigger a cell change to the target cell (DU2), and operation of the cell change may be carried out at 390.

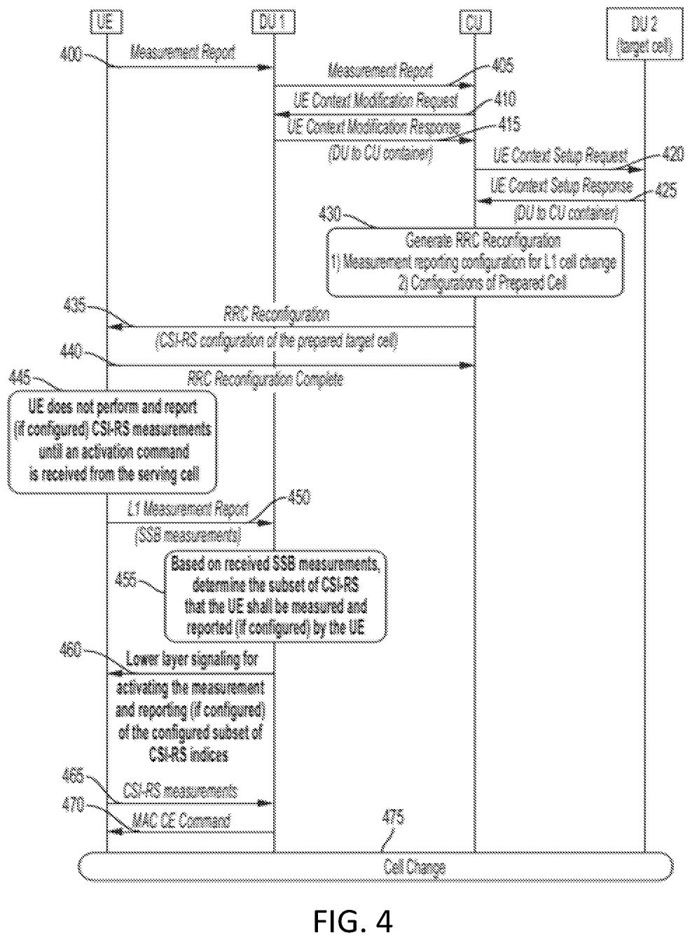

FIG. 4 illustrates an example of another signal flow diagram, according to certain example embodiments. In particular, FIG. 4 illustrates an example embodiment where measurements are performed for a subset of configured CSI-RS indices. For instance, as illustrated in FIG. 4, the UE may be configured with a large set of CSI-RS indices, but perform measurements for a subset that may be determined by the network (e.g., serving cell).

As shown in FIG. 4, operations 400 to 440 are similar to operations 100 to 145 in FIG. 1. Thus, the description of operations 300 to 345 may be similar to the above description of operations 100 to 145. However, at 435, the CU may also transmit CSI-RS configuration of the prepared target cell along with the RRC reconfiguration to the UE.

At 445, the UE may be configured by the serving cell (e.g., DU1) with a list of CSI-RS indices for each prepared target cell, and may perform and report (if configured to do so) measurements for a subset of CSI-RS indices when it receives an indication from the serving cell to do so. In other words, according to certain example embodiments, the UE may not perform and report CSI-RS measurements until the UE receives an activation command from the serving cell. At 450, the UE may transmit an L1 measurement report including SSB measurements to the serving cell. At 455, upon receiving the SSB measurements from the UE, the serving cell may identify CSI-RS indices whose source SSB RSs have the highest reported SSB measurements (e.g., any one of L1-RSRP or L1-SINR). The subset of CSI-RS indices identified by the serving cell may correspond to the CSI-RS indices that may be measured and reported by the UE.

Once the serving cell has identified the CSI-RS indices for measurement and reporting by the UE, at 460, the serving cell may transmit an activation command to the UE to activate measurement and reporting (if configure) of the configured subset of CSI-RS indices. According to certain example embodiments, the activation of the subset of CSI-RS indices may be performed by the serving cell using MAC CE or downlink control information (DCI) where the serving cell indicates to the UE the subset of CSI-RS indices that it may measure and report (if configured to do so). At 465, the UE may perform the measurements of the subset of CSI-RS indices, and report the CSI-RS measurements to the serving cell. According to certain example embodiments, the subset of CSI-RS indices is for a prepared target cell as part of L1/2 inter-cell mobility. At 470, the serving cell may transmit a MAC CE or a L1 message to the UE to trigger a cell change to the target candidate cell. At 475, handover from the serving cell to the target cell may be executed by the UE.

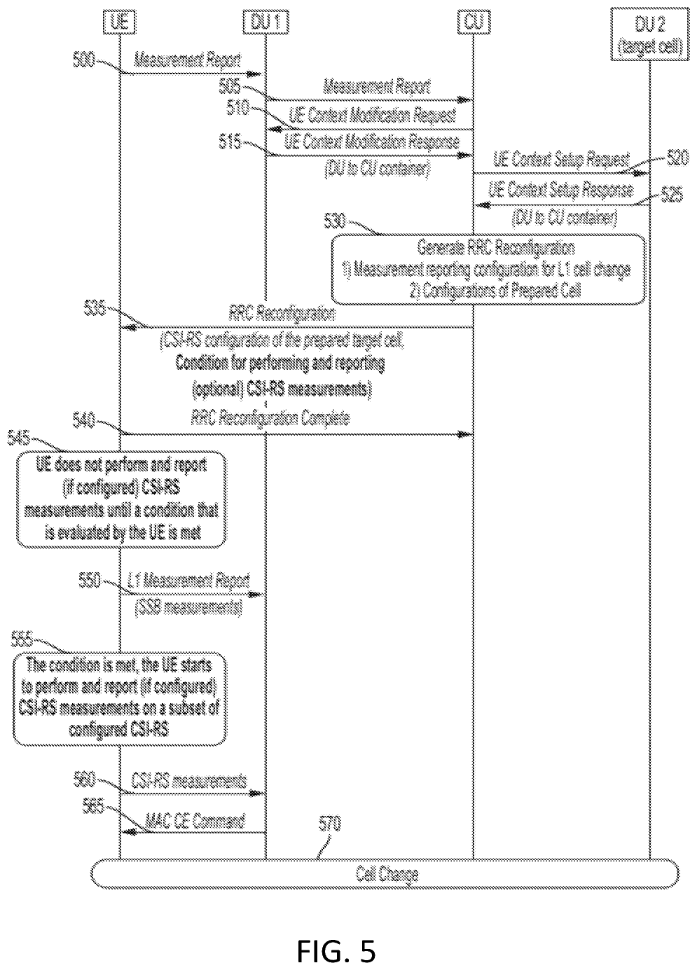

FIG. 5 illustrates an example of a further signal flow diagram, according to certain example embodiments. In particular, FIG. 5 illustrates an example embodiment where measurements are performed for a subset of configured CSI-RS indices. For instance, as illustrated in FIG. 5, the UE may be configured with a large set of CSI-RS indices, but perform measurements for a subset that is determined by the UE. Additionally, in some example embodiments, the target cell may activate the transmission of the large set of CSI-RS indices if they are not already active.

As shown in FIG. 5, operations 500 to 540 are similar to operations 100 to 145 in FIG. 1. Thus, the description of operations 500 to 540 may be similar to the above description of operations 100 to 145. However, at 535, the CU may also transmit CSI-RS configuration of the prepared target cell, and the condition(s) for performing and reporting CSI-RS measurements along with the RRC reconfiguration to the UE.

At 545, the UE may be configured by the serving cell (e.g., DU1) with a list of CSI-RS indices for each prepared target cell, and may perform and report (if configured to do so) measurements for a subset of CSI-RS indices when at least one condition that is evaluated by the UE is satisfied. At 550, the UE may transmit an L1 measurement report including SSB measurements to the serving cell. At 555, once the UE has determined that the condition has been satisfied, the UE may start to perform and report (if configured to do so) CSI-RS measurements on the subset of configured CSI-RS indices where the condition has been satisfied. At 560, the UE may perform the measurements of the subset of CSI-RS indices, and report the CSI-RS measurements to the serving cell. At 565, the serving cell may transmit a MAC CE or a L1 message to the UE to trigger a cell change to the target candidate cell. At 570, handover from the serving cell to the target cell may be executed by the UE.

According to certain example embodiments, the condition may be configured by the network (e.g., DU1, CU, or DU2), or left for the UE implementation. According to other example embodiments, the condition may be satisfied when at least one L1 SSB measurement (e.g., L1-RSRP or L1-SINR) that is better than that of the serving cell (i.e., the strongest SSB of a prepared target cell). Once the strongest SSB is detected, the UE may begin measuring and reporting (if configured to do so) the CSI-RSs whose source RS for QCL information is the detected/measured SSB (i.e., the strongest SSB) of a prepared target cell. According to some example embodiments, when there is no configured CSI-RS whose source RS for QCL information is the strongest SSB, then the UE may select to perform and report (if configured to do so) measurements for the second strongest SSB and so on. Additionally, in other example embodiments, the configuration of the radio resources used for reporting the CSI-RS measurements and the reporting configuration (e.g., measurement quantities to report such as, for example, L1-RSRP or L1-SINR) may be provided beforehand to the UE by the CU.

In certain example embodiments, the condition may be satisfied when the L1 SSB measurement of a prepared target cell is smaller than the strongest SSB measurement of a serving cell by at most X dB, where X may be configured by the serving cell. In some example embodiments, X may be 1, 2, 3, 4, and up to 24 dB. In other example embodiments, the condition may be satisfied when the (L3 or L1) measurement of the serving cell falls below a threshold and/or the (L3 or L1) measurements of the target cell exceeds a threshold. Further, in some example embodiments, irrespective of the condition type, the UE may (if configured to do so) start measuring and reporting the CSI-RS indices whose source RS for QCL information is the detected/measured SSB of a prepared target cell. Additionally, the detected/measured SSB may correspond to the strongest SSB measurement or second strongest, etc.

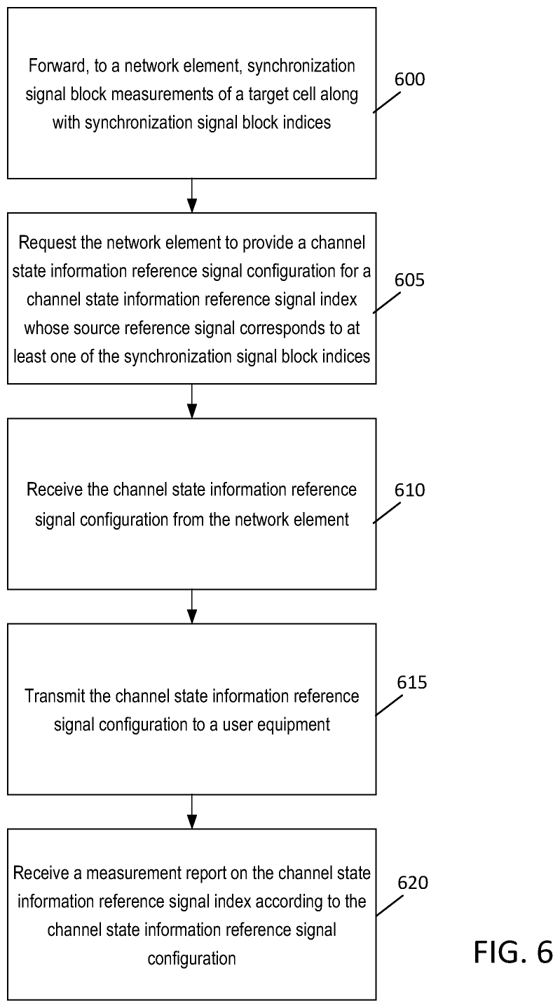

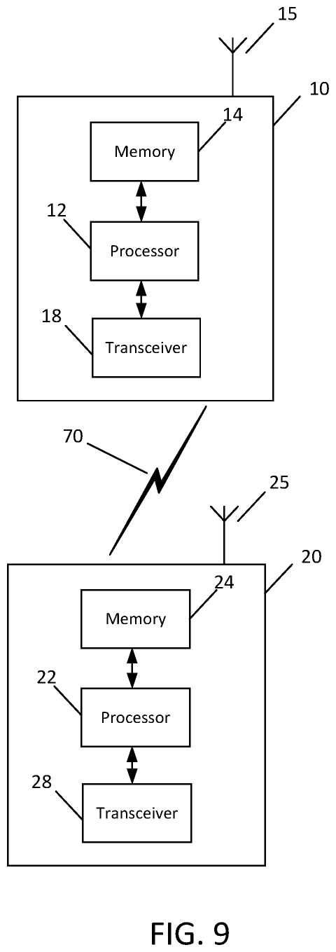

FIG. 6 illustrates an example flow diagram of a method, according to certain example embodiments. In an example embodiment, the method of FIG. 6 may be performed by a network element, or a group of multiple network elements in a 3GPP system, such as LTE or 5G-NR. For instance, in certain example embodiments, the method of FIG. 6 may be performed by a network element, serving cell, or serving DU similar to one of apparatuses 10 or 20 illustrated in FIG. 9.

According to certain example embodiments, the method of FIG. 6 may include, at 600, forwarding, to a network element, synchronization signal block measurements of a target cell along with synchronization signal block indices. The method may also include, at 605, requesting the network element to provide a channel state information reference signal configuration for a channel state information reference signal index whose source reference signal corresponds to at least one of the synchronization signal block indices. The method may further include, at 610, receiving the channel state information reference signal configuration from the network element. In addition, the method may include, at 615, transmitting the channel state information reference signal configuration to a user equipment. Further, the method may include, at 620, receiving a measurement report on the channel state information reference signal index according to the channel state information reference signal configuration.

According to certain example embodiments, the synchronization signal block indices may correspond to strongest synchronization signal block indices among a plurality of synchronization signal block indices. According to some example embodiments, the method may further include transmitting an updated list of the strongest synchronization signal block indices and synchronization signal block measurements. According to other example embodiments, the synchronization signal block measurements may include a Layer 1 reference signal received power or a Layer 1 signal to interference and noise ratio

In certain example embodiments, the synchronization signal block measurements may be the latest measurements, or average or weighted average over past measurements. In some example embodiments, the synchronization signal block measurements may be the average of synchronization signal block measurement results over a predetermined number of time periods. In other example embodiments, at least one of the synchronization signal block measurements may have to be reported by the UE in a predetermined number of times during a specified time period.

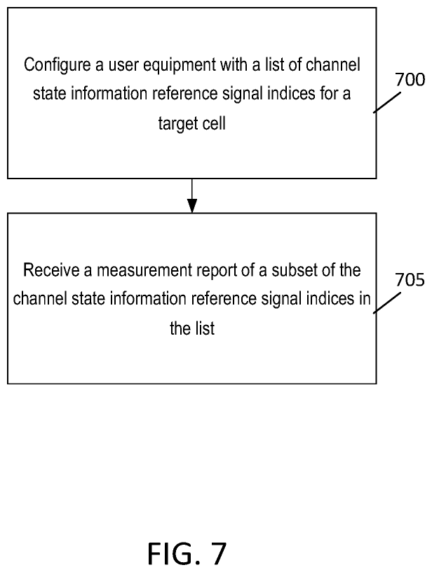

FIG. 7 illustrates an example flow diagram of a method, according to certain example embodiments. In an example embodiment, the method of FIG. 7 may be performed by a network element, or a group of multiple network elements in a 3GPP system, such as LTE or 5G-NR. For instance, in certain example embodiments, the method of FIG. 7 may be performed by a network element, serving cell, or serving DU similar to one of apparatuses 10 or 20 illustrated in FIG. 9.

According to certain example embodiments, the method of FIG. 6 may include, at 700, configuring a user equipment with a list of channel state information reference signal indices for a target cell. The method may also include, at 705, receiving a measurement report of a subset of the channel state information reference signal indices in the list. In some example embodiments, the report may be received based on an activation command from the apparatus, or based on satisfaction of a condition for the user equipment.

According to certain example embodiments, the subset of the channel state information reference signal indices may have source synchronization signal block reference signals with a highest reported synchronization signal block measurement out of a plurality of synchronization signal block measurements. According to some example embodiments, the method may also include receiving synchronization signal block measurements of a target cell. According to other example embodiments, the method may further include activating, based on the synchronization signal block measurements, the user equipment to perform measurement and reporting on the subset of channel state information reference signal indices.

In certain example embodiments, the activation of the user equipment is performed using a medium access control control element or a downlink control information. In some example embodiments, the condition may include at least one of the following: when a Layer 1 synchronization signal block measurement of a target cell is better than that of a serving cell, when the Layer 1 synchronization signal block measurement of the target cell is smaller than the Layer 1 synchronization signal block measurement of the serving cell by a predetermined decibel amount, or when a measurement of the serving cell falls below a threshold, or a measurement of the target cell exceeds a threshold.

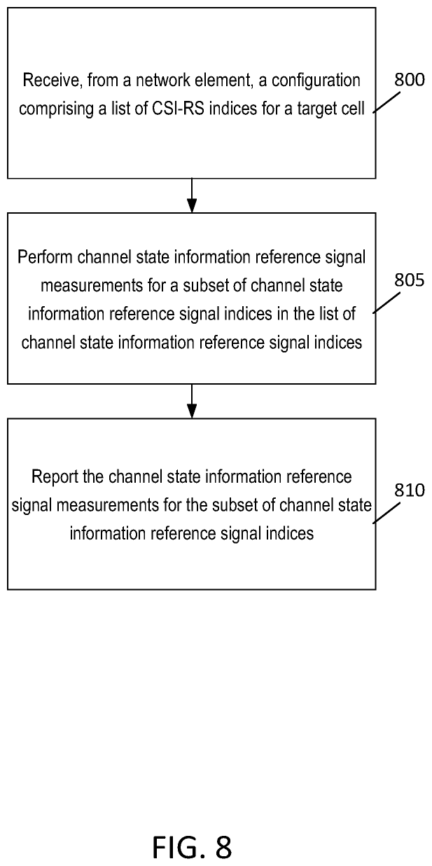

FIG. 8 illustrates an example flow diagram of a method, according to certain example embodiments. In an example embodiment, the method of FIG. 8 may be performed by a network entity, or a group of multiple network elements in a 3GPP system, such as LTE or 5G-NR. For instance, in an example embodiment, the method of FIG. 8 may be performed by a UE or SRC UE similar to one of apparatuses 10 or 20 illustrated in FIG. 9.

According to certain example embodiments, the method of FIG. 6 may include, at 800, receiving, from a network element, a configuration comprising a list of channel state information reference signal indices for a target cell. The method may also include, at 805, performing channel state information reference signal measurements for a subset of channel state information reference signal indices in the list of channel state information reference signal indices. The method may further include, at 810, reporting the channel state information reference signal measurements for the subset of channel state information reference signal indices to the network element. According to certain example embodiments, the performance and report of the channel state information reference signal measurements may be initiated based on reception of an activation command from the network element, or based on satisfaction of a condition. According to certain example embodiments, the channel state information reference signal measurements for the subset of channel state information reference signal indices are for prepared target cell as part of L1/2 inter-cell mobility.

According to certain example embodiments, the channel state information reference signal indices of the subset may be associated with a source synchronization signal block reference signal with a highest reported synchronization signal block measurement out of a plurality of synchronization signal block measurements. According to some example embodiments, the condition may include at least one of the following: when a Layer 1 synchronization signal block measurement of a target cell is better than that of a serving cell, when the Layer 1 synchronization signal block measurement of the target cell is smaller than a strongest synchronization signal block measurement out of a plurality of synchronization signal blocks for the serving cell by a predetermined decibel amount, or when a measurement of the serving cell falls below a threshold, or a measurement of the target cell exceeds a threshold. According to other example embodiments, the activation command may identify the subset of channel state information reference signal indices that is to be measured and reported.

In certain example embodiments, the method may also include transmitting synchronization signal block measurements of the target cell. In some example embodiments, the activation command to perform and report the channel state information signal block measurements may be based on the synchronization signal block measurements.

According to certain example embodiments, the method may also include receiving configuration of radio resources for reporting the channel state information reference signal measurements prior to reporting the channel state information reference signal measurements. According to other example embodiments, the method may further include, when there is no configured channel state information reference signal whose source reference signal is a strongest synchronization signal block out of a plurality of synchronization signal blocks, performing channel state information reference signal measurements for a next strongest synchronization signal block out of the plurality of synchronization signal blocks.

FIG. 9 illustrates a set of apparatuses 10 and 20 according to certain example embodiments. In certain example embodiments, the apparatus 10 may be an element in a communications network or associated with such a network, such as a UE, mobile equipment (ME), mobile station, mobile device, stationary device, IoT device, or other device. It should be noted that one of ordinary skill in the art would understand that apparatus 10 may include components or features not shown in FIG. 9.

In some example embodiments, apparatus 10 may include one or more processors, one or more computer-readable storage medium (for example, memory, storage, or the like), one or more radio access components (for example, a modem, a transceiver, or the like), and/or a user interface. In some example embodiments, apparatus 10 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 7, apparatus 10 may include or be coupled to a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 9, multiple processors may be utilized according to other example embodiments. For example, it should be understood that, in certain example embodiments, apparatus 10 may include two or more processors that may form a multiprocessor system (e.g., in this case processor 12 may represent a multiprocessor) that may support multiprocessing. According to certain example embodiments, the multiprocessor system may be tightly coupled or loosely coupled (e.g., to form a computer cluster).

Processor 12 may perform functions associated with the operation of apparatus 10 including, as some examples, precoding of antenna gain/phase parameters, encoding and decoding of individual bits forming a communication message, formatting of information, and overall control of the apparatus 10, including processes and examples illustrated in FIGS. 1-5 and 8.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In certain example embodiments, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10 to perform any of the methods and examples illustrated in FIGS. 1-5 and 8.

In some example embodiments, apparatus 10 may also include or be coupled to one or more antennas 15 for receiving a downlink signal and for transmitting via an UL from apparatus 10. Apparatus 10 may further include a transceiver 18 configured to transmit and receive information. The transceiver 18 may also include a radio interface (e.g., a modem) coupled to the antenna 15. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an UL.

For instance, transceiver 18 may be configured to modulate information on to a carrier waveform for transmission by the antenna(s) 15 and demodulate information received via the antenna(s) 15 for further processing by other elements of apparatus 10. In other example embodiments, transceiver 18 may be capable of transmitting and receiving signals or data directly. Additionally or alternatively, in some example embodiments, apparatus 10 may include an input and/or output device (I/O device). In certain example embodiments, apparatus 10 may further include a user interface, such as a graphical user interface or touchscreen.

In certain example embodiments, memory 14 stores software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software. According to certain example embodiments, apparatus 10 may optionally be configured to communicate with apparatus 20 via a wireless or wired communications link 70 according to any radio access technology, such as NR.

According to certain example embodiments, processor 12 and memory 14 may be included in or may form a part of processing circuitry or control circuitry. In addition, in some example embodiments, transceiver 18 may be included in or may form a part of transceiving circuitry.

For instance, in certain example embodiments, apparatus 10 may be controlled by memory 14 and processor 12 to receive, from a network element, a configuration comprising a list of channel state information reference signal indices for a target cell. Apparatus 10 may also be controlled by memory 14 and processor 12 to perform channel state information reference signal measurements for a subset of channel state information reference signal indices in the list of channel state information reference signal indices. Apparatus 10 may further be controlled by memory 14 and processor 12 to report the channel state information reference signal measurements for the subset of channel state information reference signal indices to the network element. According to certain example embodiments, the performance and report of the channel state information reference signal measurements may be initiated based on reception of an activation command from the network element, or based on satisfaction of a condition.

As illustrated in the example of FIG. 9, apparatus 20 may be a network, core network element, or element in a communications network or associated with such a network, such as a gNB, NW, serving cell, target cell, DU1, DU2, or CU. It should be noted that one of ordinary skill in the art would understand that apparatus 20 may include components or features not shown in FIG. 9.

As illustrated in the example of FIG. 9, apparatus 20 may include a processor 22 for processing information and executing instructions or operations. Processor 22 may be any type of general or specific purpose processor. For example, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 9, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

According to certain example embodiments, processor 22 may perform functions associated with the operation of apparatus 20, which may include, for example, precoding of antenna gain/phase parameters, encoding and decoding of individual bits forming a communication message, formatting of information, and overall control of the apparatus 20, including processes and examples illustrated in FIGS. 1-7.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In certain example embodiments, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20 to perform the methods and examples illustrated in FIGS. 1-7.

In certain example embodiments, apparatus 20 may also include or be coupled to one or more antennas 25 for transmitting and receiving signals and/or data to and from apparatus 20. Apparatus 20 may further include or be coupled to a transceiver 28 configured to transmit and receive information. The transceiver 28 may include, for example, a plurality of radio interfaces that may be coupled to the antenna(s) 25. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an UL).

As such, transceiver 28 may be configured to modulate information on to a carrier waveform for transmission by the antenna(s) 25 and demodulate information received via the antenna(s) 25 for further processing by other elements of apparatus 20. In other example embodiments, transceiver 18 may be capable of transmitting and receiving signals or data directly. Additionally or alternatively, in some example embodiments, apparatus 20 may include an input and/or output device (I/O device).

In certain example embodiment, memory 24 may store software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to some example embodiments, processor 22 and memory 24 may be included in or may form a part of processing circuitry or control circuitry. In addition, in some example embodiments, transceiver 28 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10 and 20) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

For instance, in certain example embodiments, apparatus 10 may be controlled by memory 14 and processor 12 to forward, to a network element, synchronization signal block measurements of a target cell along with synchronization signal block indices. Apparatus 10 may also be controlled by memory 14 and processor 12 to request the network element to provide a channel state information reference signal configuration for a channel state information reference signal index whose source reference signal corresponds to at least one of the synchronization signal block indices. Apparatus 10 may further be controlled by memory 14 and processor 12 to receive the channel state information reference signal configuration from the network element. In addition, apparatus 10 may be controlled by memory 14 and processor 12 to transmit the channel state information reference signal configuration to a user equipment. Further, apparatus 10 may be controlled by memory 14 and processor 12 to receive a measurement report on the channel state information reference signal index according to the channel state information reference signal configuration.

In other example embodiments, apparatus 10 may be controlled by memory 14 and processor 12 to configure a user equipment with a list of channel state information reference signal indices for a target cell. Apparatus 10 may further be controlled by memory 14 and processor 12 to receive a measurement report of a subset of the channel state information reference signal indices in the list. According to certain example embodiments, the report may be received based on an activation command from the apparatus, or based on satisfaction of a condition for the user equipment.

In some example embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of the operations.

Certain example embodiments may be directed to an apparatus that includes means for performing any of the methods described herein including, for example, means for receiving, from a network element, a configuration comprising a list of channel state information reference signal indices for a target cell. The apparatus may also include means for performing channel state information reference signal measurements for a subset of channel state information reference signal indices in the list of channel state information reference signal indices. The apparatus may further include means for reporting the channel state information reference signal measurements for the subset of channel state information reference signal indices to the network element. According to certain example embodiments, the performance and report of the channel state information reference signal measurements may be initiated based on reception of an activation command from the network element, or based on satisfaction of a condition.

Other example embodiments may be directed to an apparatus that includes means for performing any of the methods described herein including, for example, means for forwarding, to a network element, synchronization signal block measurements of a target cell along with synchronization signal block indices. The apparatus may also include means for requesting the network element to provide a channel state information reference signal configuration for a channel state information reference signal index whose source reference signal corresponds to at least one of the synchronization signal block indices. The apparatus may further include means for receiving the channel state information reference signal configuration from the network element. In addition, the apparatus may include means for transmitting the channel state information reference signal configuration to a user equipment. Further, the apparatus may include means for receiving a measurement report on the channel state information reference signal index according to the channel state information reference signal configuration.

Further example embodiments may be directed to an apparatus that includes means for performing any of the methods described herein including, for example, means for configuring a user equipment with a list of channel state information reference signal indices for a target cell. The apparatus may also include means for receiving a measurement report of a subset of the channel state information reference signal indices in the list. According to certain example embodiments, the report may be received based on an activation command from the apparatus, or based on satisfaction of a condition for the user equipment.

Certain example embodiments described herein provide several technical improvements, enhancements, and/or advantages. For instance, in some example embodiments, it may be possible for the UE to perform and report (if configured to do so) CSI-RS measurements only for the relevant CSI-RS indices. In other example embodiments, it may be possible for the target cell to avoid unnecessarily transmitting all the CSI-RS. That is, according to certain example embodiments, it may be possible to reduce unnecessary CSI-RS configurations and transmissions performed by the prepared target cells, and reduce the unnecessary CSI-RS measurements performed by the UE.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

Partial Glossary:

| | |
|---|---|
| 3GPP | 3rd Generation Partnership Project |
| 5G | 5th Generation |
| 5GCN | 5G Core Network |
| 5GS | 5G System |
| BS | Base Station |
| CSI-RS | Channel State Information Reference signal |
| CU | Centralized Unit |
| DCI | Downlink Control Information |
| DL | Downlink |
| eNB | Enhanced Node B |
| E-UTRAN | Evolved UTRAN |
| gNB | 5G or Next Generation NodeB |
| L1 | Layer 1 |
| L3 | Layer 3 |
| LLM | Lower Layer Mobility |
| LTE | Long Term Evolution |
| MAC | Medium Access Control |
| NR | New Radio |
| NW | Network |
| NZP | Non-Zero Power |
| PDCCH | Physical Downlink Control Channel |
| PDSCH | Physical Downlink Shared Channel |
| PUCCH | Physical Uplink Control Channel |
| PUSCH | Physical Uplink Shared Channel |
| QCL | Quasi Co-Location |
| QoS | Quality of Service |
| RRC | Radio Resource Control |
| RS | Reference Signal |
| SINR | Signal to Interference and Noise Ratio |
| SSB | Synchronization Signal Block |
| TCI | Transmission Configuration Index |
| TRS | Tracking Reference Signal |
| UE | User Equipment |
| UL | Uplink |

We claim:

1. An apparatus, comprising:
at least one processor; and
at least one memory comprising computer program code,
the at least one memory and the computer program code configured to, with the at least one processor, cause the apparatus at least to
forward, to a network element, synchronization signal block measurements of a target cell along with synchronization signal block indices;
request the network element to provide a channel state information reference signal configuration for a channel state information reference signal index whose source reference signal corresponds to at least one of the synchronization signal block indices;
receive the channel state information reference signal configuration from the network element;
transmit the channel state information reference signal configuration to a user equipment; and
receive a measurement report on the channel state information reference signal index according to the channel state information reference signal configuration.

2. The apparatus according to claim 1, wherein the synchronization signal block indices correspond to strongest synchronization signal block indices among a plurality of synchronization signal block indices.

3. The apparatus according to claim 2, wherein the at least one memory and the computer program code are further configured to, with the at least one processor, cause the apparatus at least to:
transmit an updated list of the strongest synchronization signal block indices and synchronization signal block measurements.

4. The apparatus according to claim 1, wherein the synchronization signal block measurements comprise a Layer 1 reference signal received power or a Layer 1 signal to interference and noise ratio.

5. The apparatus according to claim 1, wherein the synchronization signal block measurements are the latest measurements, or average or weighted average over past measurements.

6. The apparatus according to claim 1, wherein the synchronization signal block measurements are the average of synchronization signal block measurement results over a predetermined number of time periods.

7. The apparatus according to claim 1, wherein at least one of the synchronization signal measurements is received in a predetermined number of times during a specified time period.

8. An apparatus, comprising:
at least one processor; and
at least one memory comprising computer program code,
the at least one memory and the computer program code configured to, with the at least one processor, cause the apparatus at least to
configure a user equipment with a list of channel state information reference signal indices for a target cell; and
receive a measurement report of a subset of the channel state information reference signal indices in the list;
wherein the report is received based on an activation command from the apparatus, or based on satisfaction of a condition for the user equipment.

9. The apparatus according to claim 8, wherein the subset of the channel state information reference signal indices have source synchronization signal block reference signals with a highest reported synchronization signal block measurement out of a plurality of synchronization signal block measurements.

10. The apparatus according to claim 8, wherein the at least one memory and the computer program code are further configured to, with the at least one processor, cause the apparatus at least to:
receive synchronization signal block measurements of a target cell; and
activate, based on the synchronization signal block measurements, the user equipment to perform measurement and reporting on the subset of channel state information reference signal indices.

11. The apparatus according to claim 10, wherein the performing and reporting on the subset of channel state information reference signal indices are for a prepared target cell as part of Layer 1 or Layer 2 inter-cell mobility.

12. The apparatus according to claim 10, wherein the activation of the user equipment is performed using a medium access control control element or a downlink control information.

13. The apparatus according to claim 8, wherein the condition comprises at least one of the following:
when a Layer 1 synchronization signal block measurement of a target cell is better than that of a serving cell,
when the Layer 1 synchronization signal block measurement of the target cell is smaller than the Layer 1 synchronization signal block measurement of the serving cell by a predetermined decibel amount, or when a measurement of the serving cell falls below a threshold, or a measurement of the target cell exceeds a threshold.

14. An apparatus, comprising:
at least one processor; and
at least one memory comprising computer program code,
the at least one memory and the computer program code configured to, with the at least one processor, cause the apparatus at least to
receive, from a network element, a configuration comprising a list of channel state information reference signal indices for a target cell;
perform channel state information reference signal measurements for a subset of channel state information reference signal indices in the list of channel state information reference signal indices; and
report the channel state information reference signal measurements for the subset of channel state information reference signal indices to the network element,
wherein the performance and report of the channel state information reference signal measurements are initiated based on reception of an activation command from the network element, or based on satisfaction of a condition.

15. The apparatus according to claim 14, wherein the channel state information reference signal indices of the subset are associated with a source synchronization signal block reference signal with a highest reported synchronization signal block measurement out of a plurality of synchronization signal block measurements.

16. The apparatus according to claim 14, wherein the condition comprises at least one of the following:
when a Layer 1 synchronization signal block measurement of a target cell is better than that of a serving cell,
when the Layer 1 synchronization signal block measurement of the target cell is smaller than the Layer 1 synchronization signal block measurement of the serving cell by a predetermined decibel amount, or
when a measurement of the serving cell falls below a threshold, or a measurement of the target cell exceeds a threshold.

17. The apparatus according to claim 14, wherein the activation command identifies the subset of channel state information reference signal indices that is to be measured and reported.

18. The apparatus according to claim 14, wherein the at least one memory and the computer program code are further configured to, with the at least one processor, cause the apparatus at least to:
transmit synchronization signal block measurements of the target cell,
wherein the activation command to perform and report the channel state information signal block measurements is based on the synchronization signal block measurements.

19. The apparatus according to claim 14, wherein the at least one memory and the computer program code are further configured to, with the at least one processor, cause the apparatus at least to:
receive configuration of radio resources for reporting the channel state information reference signal measurements prior to reporting the channel state information reference signal measurements.

20. The apparatus according to claim 14, wherein the at least one memory and the computer program code are further configured to, with the at least one processor, cause the apparatus at least to:
when there is no configured channel state information reference signal whose source reference signal is a strongest synchronization signal block out of a plurality of synchronization signal blocks, perform channel state information reference signal measurements for a next strongest synchronization signal block out of the plurality of synchronization signal blocks.
